(19) United States
(12) Patent Application Publication
(10) Pub. No.: US 2013/0156004 A1
(43) Pub. Date: Jun. 20, 2013

(54) TECHNIQUES TO PERFORM EVOLVED HIGH RATE PACKET DATA (eHRPD) NETWORK SPECIFIC SCANNING

(71) Applicants: Arvind Swaminathan, San Diego, CA (US); Manasi Dhiren Gandhi, San Diego, CA (US); Rajashekar Chilla, San Diego, CA (US)

(72) Inventors: Arvind Swaminathan, San Diego, CA (US); Manasi Dhiren Gandhi, San Diego, CA (US); Rajashekar Chilla, San Diego, CA (US)

(73) Assignee: QUALCOMM INCORPORATED, San Diego, CA (US)

(21) Appl. No.: 13/326,223

(22) Filed: Dec. 14, 2011

(51) Int. Cl. H04W 36/00

(52) U.S. Cl. 370/331

(57) ABSTRACT

Evolved High Rate Packet Data (eHRPD) network specific scanning process includes storing first network information indicating whether a channel frequency corresponds to an evolved High Rate Packet Data (eHRPD) network within a first persistent memory. The process also includes storing second network information indicating whether the channel frequency corresponds to a High Rate Packet Data (HRPD) network within a second persistent memory. The process further includes maintaining Internet Protocol (IP) continuity according to the first and second network information stored within the first and second persistent memories.

### BACKGROUND

1. Field

Aspects of the present disclosure relate generally to wireless communication systems, and more particularly to performing evolved High Rate Packet Data (eHRPD) network specific scanning.

2. Background

Wireless communication networks are widely deployed to provide various communication services such as voice, video, packet data, messaging, broadcast, etc. These wireless networks may be multiple-access networks capable of supporting multiple users by sharing the available network resources. A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance the UMTS technologies not only to meet the growing demand for mobile broadband access, but to advance and enhance the user experience with mobile communications.

### SUMMARY

According to one aspect of the present disclosure, a method for performing evolved High Rate Packet Data (eHRPD) network specific scanning is described. The method includes storing first network information indicating whether a channel frequency corresponds to an evolved High Rate Packet Data (eHRPD) network within a first persistent memory. The method also includes storing second network information indicating whether the channel frequency corresponds to a High Rate Packet Data (HRPD) network within a second persistent memory. The method further includes maintaining Internet Protocol (IP) continuity according to the first and second network information stored within the first and second persistent memories.

In another aspect, an apparatus for performing evolved High Rate Packet Data (eHRPD) network specific scanning is described. The apparatus includes at least one processor and a memory coupled to the at least one processor. The processor(s) is configured to store first network information indicating whether a channel frequency corresponds to an evolved High Rate Packet Data (eHRPD) network within a first persistent memory. The processor(s) is also configured to store second network information indicating whether the channel frequency corresponds to a High Rate Packet Data (HRPD) network within a second persistent memory. The processor(s) is further configured to maintain Internet Protocol (IP) continuity according to the first and second network information stored within the first and second persistent memories.

In a further aspect, a computer program product for performing evolved High Rate Packet Data (eHRPD) network specific scanning is described. The computer program product includes a non-transitory computer-readable medium having program code recorded thereon. The computer program product has program code to store first network information indicating whether a channel frequency corresponds to an evolved High Rate Packet Data (eHRPD) network within a first persistent memory. The computer program product also includes program code configured to store second network information indicating whether the channel frequency corresponds to a High Rate Packet Data (HRPD) network within a second persistent memory. The computer program product further includes program code to maintain an Internet Protocol (IP) continuity according to the first and second network information stored within the first and second persistent memories.

In another aspect, an apparatus for performing evolved High Rate Packet Data (eHRPD) network specific scanning is described. The apparatus includes means for storing first network information indicating whether a channel frequency corresponds to an evolved High Rate Packet Data (eHRPD) network within a first persistent memory. The apparatus also includes means for storing second network information indicating whether the channel frequency corresponds to a High Rate Packet Data (HRPD) network within a second persistent memory. The apparatus further includes means for maintaining Internet Protocol (IP) continuity according to the first and second network information stored within the first and second persistent memories.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 illustrates a method for performing evolved High Rate Packet Data (eHRPD) network specific scanning in response to an LTE out of service (OOS) event, according to another aspect of the present disclosure.

FIG. 3 illustrates a method for performing evolved High Rate Packet Data (eHRPD) network specific scanning in response to an LTE to EV-DO redirection failure, according to another aspect of the present disclosure.

FIG. 4 is a block diagram conceptually illustrating a design of a base station/eNodeB and a UE configured according to one aspect of the present disclosure.

FIG. 5 is a block diagram illustrating an evolved High Rate Packet Data (HRPD) (eHRPD) network, according to one aspect of the present disclosure.

FIG. 6 is a block diagram illustrating a method for performing evolved High Rate Packet Data (eHRPD) network specific scanning, according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as evolved High Rate Packet Data (eHRPD), Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA) and other networks. The terms “network” and “system” are often used interchangeably. A CDMA network may implement a radio technology, such as Universal Terrestrial Radio Access (UTRA), Telecommunications Industry Association's (TIA's) CDMA2000®, and the like. The UTRA technology includes Wideband CDMA (WCDMA) and other variants of CDMA. The CDMA2000® technology includes the IS-2000, IS-95 and IS-856 standards from the Electronics Industry Alliance (EIA) and TIA. A TDMA network may implement a radio technology, such as Global System for Mobile Communications (GSM). An OFDMA network may implement a radio technology, such as Evolved UTRA (E-UTRA), Ultra Mobile Broadband (UMB), IEEE 802.11 (Wi-Fi), IEEE 802.16 (WiMAX), IEEE 802.20, Flash-OFDMA, and the like. The UTRA and E-UTRA technologies are part of Universal Mobile Telecommunication System (UMTS).

3GPP Long Term Evolution (LTE) and LTE-Advanced (LTE-A) are newer releases of the UMTS that use E-UTRA. UTRA, E-UTRA, UMTS, LTE, LTE-A and GSM are described in documents from an organization called the “3rd Generation Partnership Project” (3GPP). CDMA2000® and UMB are described in documents from an organization called the “3rd Generation Partnership Project 2” (3GPP2). The techniques described herein may be used for the wireless networks and radio access technologies mentioned above, as well as other wireless networks and radio access technologies. For clarity, certain aspects of the techniques are described below for LTE or LTE-A (together referred to in the alternative as “LTE/-A”) and use such LTE/-A terminology in much of the description below.

The 3GPP2 organization first introduced a High Rate Packet Data (HRPD) system that used various advanced optimization techniques for data traffic. The advanced techniques used by the HRPD system included channel sensitive scheduling, fast link adaptation, Hybrid Automatic Repeat reQuest (HARM), and the like. The HRPD system initially employed a separate 1.25 megahertz (MHz) carrier and supported no voice service. As a result, HRDP was initially referred to as CDMA2000-EV-DO (evolution data only) system. Evolved HRDP (eHRPD) is an upgrade of the existing HRPD (EV-DO) networks. In particular, eHRPD allows EV-DO service providers to introduce System Architecture Evolution (SAE)/Evolved Packet Core (EPC) architecture elements to their existing packet core.

eHRPD networks may be referred to as hybrid networks for bridging the gap between HRPD networks and LTE networks. eHRPD networks are hybrid networks because the radio network is 3GPP2 (e.g., EV-DO RevA/RevB) and the core network is 3GPP (EPC). eHRPD is a method that allows the mobile operator to upgrade their existing HRPD packet core network using elements of the SAE/EPC architecture. Additionally, eHRPD is an evolutionary path to LTE allowing for seamless service mobility between the eHRPD and LTE networks. Because SAE is an all-IP network infrastructure, the network can quickly move to mobile VoIP (voice over IP) for voice. Moreover, with the introduction of eHRPD, the operator can leverage the benefit of optimized eHRPD handover when the user crosses HRPD serving gateway (HSGW) boundaries.

In one aspect of the present disclosure, a user equipment (UE) scanning preference is described for identifying an eHRPD network. In one aspect of the present disclosure, an enhancement of UE multimode system selection is described for performing eHRPD specific scanning. In particular, UE multimode system selection may be biased toward performing eHRPD specific scanning for maintaining an Internet Protocol (IP) continuity between eHRPD and LTE networks. In one configuration, the UE stores first network information regarding whether a channel frequency corresponds to an eHRPD network within a first persistent memory. In this aspect of the present disclosure, the UE also stores second network information regarding whether the channel frequency corresponds to an HRPD network within a second persistent memory. In this configuration, the UE multimode system selection process maintains IP continuity according to the first and second network information stored within the first and second persistent memories.

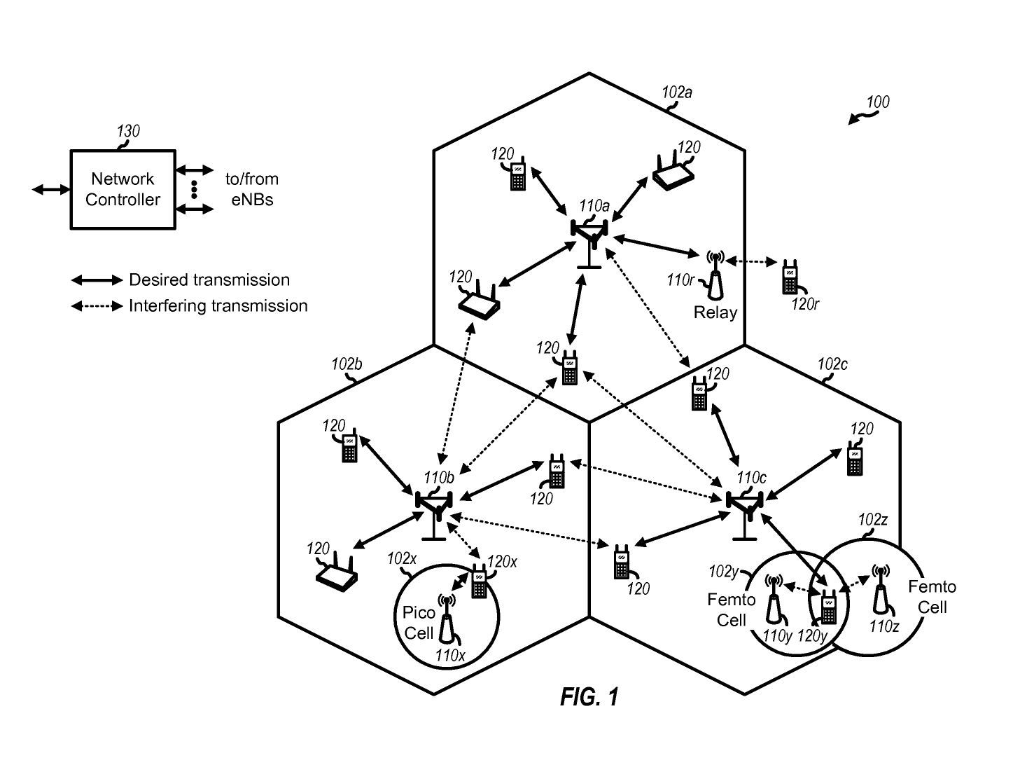

FIG. 1 shows a wireless communication network 100, which may be an LTE-A network, in which a UE 120 performs evolved High Rate Packet Data (HRPD) (eHRPD) network specific scanning for maintaining IP continuity between LTE and eHRPD networks, according to one aspect of the present disclosure. The wireless network 100 includes a number of evolved node Bs (eNodeBs) 110 and other network entities. An eNodeB may be a station that communicates with the UEs and may also be referred to as a base station, a node B, an access point, and the like. Each eNodeB 110 may provide communication coverage for a particular geographic area. In 3GPP, the term “cell” can refer to this particular geographic coverage area of an eNodeB and/or an eNodeB subsystem serving the coverage area, depending on the context in which the term is used.

An eNodeB may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNodeB for a macro cell may be referred to as a macro eNodeB. An eNodeB for a pico cell may be referred to as a pico eNodeB. And, an eNodeB for a femto cell may be referred to as a femto eNodeB or a home eNodeB. In the example shown in FIG. 1, the eNodeBs 110a, 110b and 110c are macro eNodeBs for the macro cells 102a, 102b and 102c, respectively. The eNodeB 110x is a pico eNodeB for a pico cell 102x. And, the eNodeBs 110y and 110z are femto eNodeBs for the femto cells 102y and 102z, respectively. An eNodeB may support one or multiple (e.g., two, three, four, and the like) cells.

The wireless network 100 may also include relay stations. A relay station is a station that receives a transmission of data and/or other information from an upstream station (e.g., an eNodeB, UE, etc.) and sends a transmission of the data and/or other information to a downstream station (e.g., a UE or an eNodeB). A relay station may also be a UE that relays transmissions for other UEs. In the example shown in FIG. 1, a relay station 110r may communicate with the eNodeB 110a and a UE 120r in order to facilitate communication between the eNodeB 110a and the UE 120r. A relay station may also be referred to as a relay eNodeB, a relay, etc.

The wireless network 100 may be a heterogeneous network that includes eNodeBs of different types, e.g., macro eNodeBs, pico eNodeBs, femto eNodeBs, relays, etc. These different types of eNodeBs may have different transmit power levels, different coverage areas, and different impact on interference in the wireless network 100. For example, macro eNodeBs may have a high transmit power level (e.g., 20 Watts) whereas pico eNodeBs, femto eNodeBs and relays may have a lower transmit power level (e.g., 1 Watt).

The wireless network 100 may support synchronous or asynchronous operation. For synchronous operation, the eNodeBs may have similar frame timing, and transmissions from different eNodeBs may be approximately aligned in time. For asynchronous operation, the eNodeBs may have different frame timing, and transmissions from different eNodeBs may not be aligned in time. The techniques described herein may be used for either synchronous or asynchronous operations.

In one aspect, the wireless network 100 may support Frequency Division Duplex (FDD) or Time Division Duplex (TDD) modes of operation. The techniques described herein may be used for either FDD or TDD mode of operation.

A network controller 130 may couple to a set of eNodeBs 110 and provide coordination and control for these eNodeBs 110. The network controller 130 may communicate with the eNodeBs 110 via a backhaul. The eNodeBs 110 may also communicate with one another, e.g., directly or indirectly via a wireless backhaul or a wireline backhaul.

The UEs 120 are dispersed throughout the wireless network 100, and each UE may be stationary or mobile. A UE may also be referred to as a terminal, a mobile station, a subscriber unit, a station, or the like. A UE may be a cellular phone, a personal digital assistant (PDA), a wireless modem, a wireless communication device, a handheld device, a laptop computer, a cordless phone, a wireless local loop (WLL) station, a tablet, or the like. A UE may be able to communicate with macro eNodeBs, pico eNodeBs, femto eNodeBs, relays, and the like. In FIG. 1, a solid line with double arrows indicates desired transmissions between a UE and a serving eNodeB, which is an eNodeB designated to serve the UE on the downlink and/or uplink. A dashed line with double arrows indicates interfering transmissions between a UE and an eNodeB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, or the like. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal FFT size may be equal to 128, 256, 512, 1024 or 2048 for a corresponding system bandwidth of 1.25, 2.5, 5, 10 or 20 megahertz (MHz), respectively. The system bandwidth may also be partitioned into sub-bands. For example, a sub-band may cover 1.08 MHz (i.e., 6 resource blocks), and there may be 1, 2, 4, 8 or 16 sub-bands for a corresponding system bandwidth of 1.25, 2.5, 5, 10, 15 or 20 MHz, respectively.

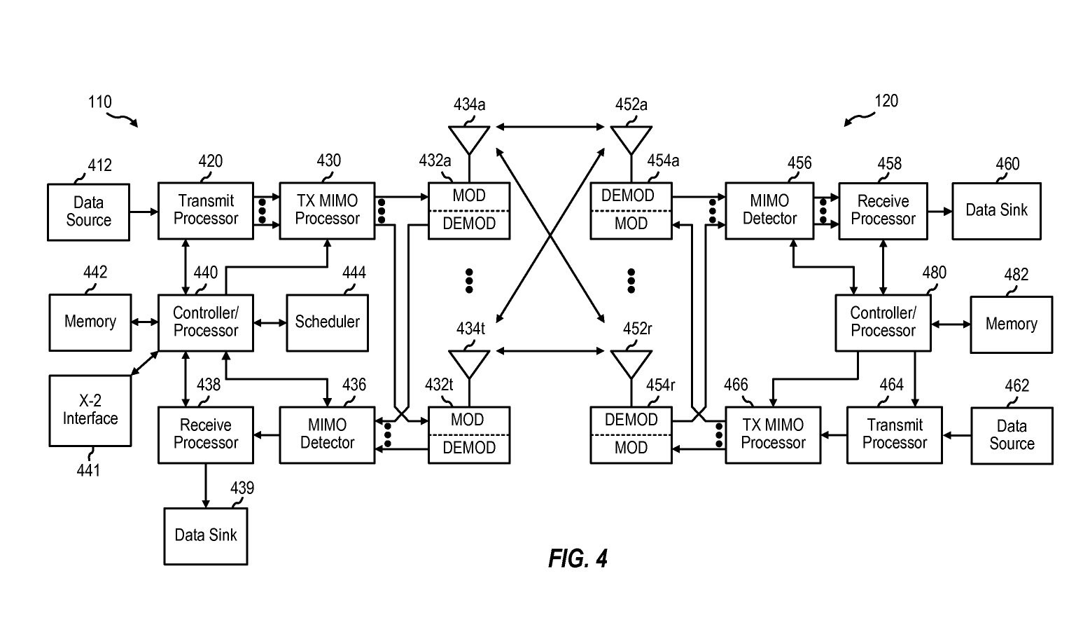

FIG. 4 shows a block diagram of a design of a base station/eNodeB 110 and a UE 120, which may be one of the base stations/eNodeBs and one of the UEs in FIG. 1. The base station 110 may be the macro eNodeB 110c in FIG. 1, and the UE 120 may be the UE 120y. The base station 110 may also be a base station of some other type. The base station 110 may be equipped with antennas 434a through 434t, and the UE 120 may be equipped with antennas 452a through 452r.

At the base station 110, a transmit processor 420 may receive data from a data source 412 and control information from a controller/processor 440. The control information may be for the PBCH, PCFICH, PHICH, PDCCH, etc. The data may be for the PDSCH, etc. The processor 420 may process (e.g., encode and symbol map) the data and control information to obtain data symbols and control symbols, respectively. The processor 420 may also generate reference symbols, e.g., for the PSS, SSS, and cell-specific reference signal. A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator 432 may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120, the antennas 452a through 452r may receive the downlink signals from the base station 110 and may provide received signals to the demodulators (DEMODs) 454a through 454r, respectively. Each demodulator 454 may condition (e.g., filter, amplify, downconvert, and digitize) a respective received signal to obtain input samples. Each demodulator 454 may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120 to a data sink 460, and provide decoded control information to a controller/processor 480.

On the uplink, at the UE 120, a transmit processor 464 may receive and process data (e.g., for the PUSCH) from a data source 462 and control information (e.g., for the PUCCH) from the controller/processor 480. The processor 464 may also generate reference symbols for a reference signal. The symbols from the transmit processor 464 may be precoded by a TX MIMO processor 466 if applicable, further processed by the modulators 454a through 454r (e.g., for SC-FDM, etc.), and transmitted to the base station 110. At the base station 110, the uplink signals from the UE 120 may be received by the antennas 434, processed by the demodulators 432, detected by a MIMO detector 436 if applicable, and further processed by a receive processor 438 to obtain decoded data and control information sent by the UE 120. The processor 438 may provide the decoded data to a data sink 439 and the decoded control information to the controller/processor 440. The base station 110 can send messages to other base stations, for example, over an X2 interface 441.

The controllers/processors 440 and 480 may direct the operation at the base station 110 and the UE 120, respectively. The processor 440 and/or other processors and modules at the base station 110 may perform or direct the execution of various processes for the techniques described herein. The processor 480 and/or other processors and modules at the UE 120 may also perform or direct the execution of the functional blocks illustrated in use method flow chart FIG. 15, and/or other processes for the techniques described herein. The memories 442 and 482 may store data and program codes for the base station 110 and the UE 120, respectively. A scheduler 444 may schedule UEs for data transmission on the downlink and/or uplink.

Techniques to Perform Evolved High Rate Packet Data (eHRPD) Network Specific Scanning

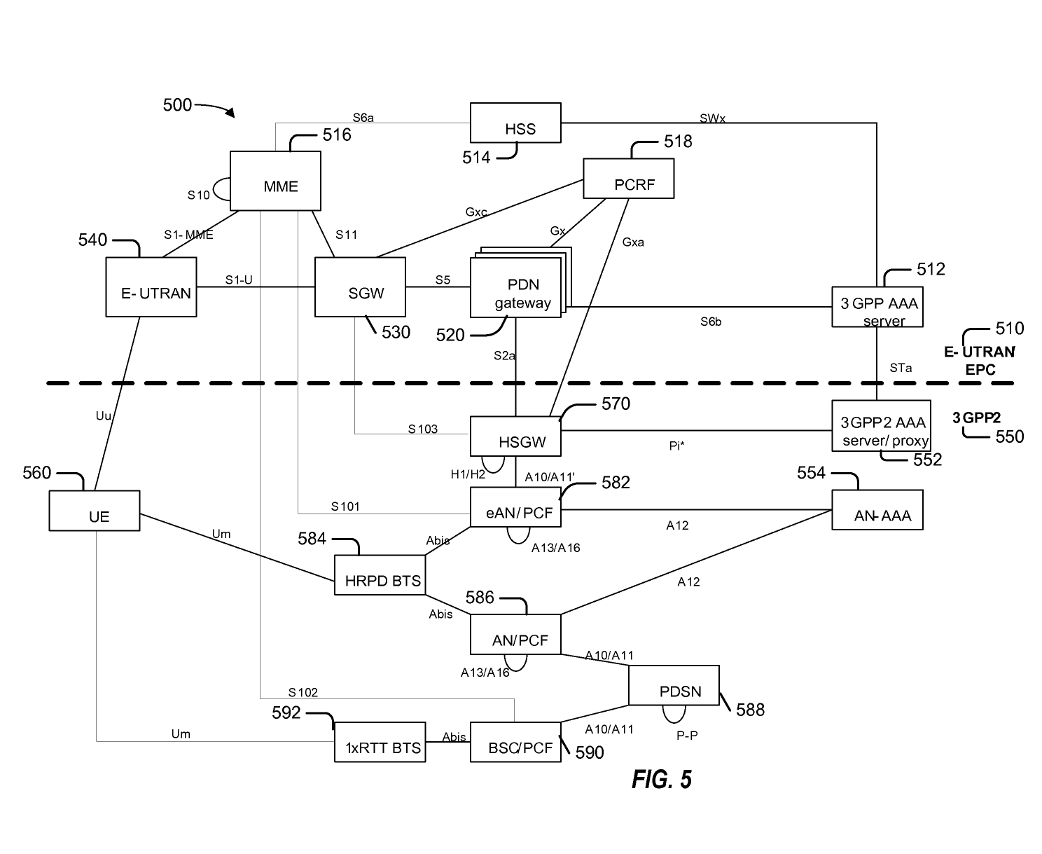

Evolved High Rate Packet Data (eHRPD) networks may be referred to as hybrid networks for bridging the gap between HRPD networks and LTE networks. FIG. 5 illustrates an eHRPD network 500, according to one aspect of the present disclosure. In this configuration, the eHRPD network 500 includes an evolved packet core (EPC) network 510 and a radio access network (RAN) 550. The RAN 550 includes an authentication, authorization and accounting (AAA) server/proxy 552, an access network (AN) AAA (AN-AAA) 554, an evolved AN/packet control function (PCF) (eAN/PCF) 582, an HRPD base transceiver station (BTS) 584, an access network packet control function AN/PCF 586, a packet data serving node (PDSN) 588, a base station controller (BSC)/PCF 590, and a 1x radio transmission technology (1xRTT) BTS 592.

Representatively, the eHRPD network 500 may be referred to as a hybrid network because the RAN 550 is in accordance with 3GPP2 (3rd Generation Partnership Project 2) and the EPC network 510 is in accordance with 3GPP (3rd Generation Partnership Project). In this configuration, a user equipment (UE) 560 operates with the 3GPP2 RAN 550 and the EPC network 510 according to an HRPD serving gateway (HSGW) 570 of the RAN 550 and a packet data network (PDN) gateway (PDN-GW) 520 of the EPC network 510. As further shown in FIG. 5, the EPC network 510 include a 3GPP AAA server 512, a serving gateway (SGW) 530, an evolved UMTS Terrestrial Radio Access Network (E-UTRAN) 540 (such as the eNodeB 10), a mobility management entity (MME) 516, a home subsriber server (HSS) 514, and a policy and changing rules function (PCRF) 518. It is noted that the different interface protocols, (such as Sl-U between the E-UTRAN 540 and the SGW 530; or Abis between the various components in the 3 GpPP2 network) are merely exemplary. Other interfaces are also contemplated.

In one aspect of the present disclosure, a user equipment (UE) scanning preference is described for identifying an eHRPD network. An enhancement of a UE multimode system selection is described for performing eHRPD specific scanning. In particular, UE multimode system selection may be biased toward performing eHRPD specific scanning for maintaining IP continuity between eHRPD and LTE networks. In one configuration, the UE stores first network information indicating whether a channel frequency corresponds to an eHRPD network within a first persistent memory. In this aspect of the present disclosure, the UE also stores second network information indicating whether the channel frequency corresponds to an HRPD network within a second persistent memory. In this configuration, the UE multimode system selection process maintains Internet Protocol (IP) continuity according to the first and second network information stored within the first and second persistent memories.

During operation, a UE may benefit from including a UE multimode system selection preference toward eHRPD systems. Unfortunately, without the improved process of the present disclosure, a UE generally performs a session negotiation without determining whether a channel corresponds to an HRPD network or an eHRPD network. A scanning preference toward eHRPD systems, however, involves a priori knowledge of whether a channel corresponds to a network upgraded from an HRPD network to an eHRPD network.

For example, during UE operation within an LTE network, the UE may incur an out of service (OOS) event. Lack of a priori knowledge of which channels correspond to an eHRPD network may result in a UE application failure due to lost IP continuity if the UE hands over to an HRPD network. Conversely, scanning that is focused on channels that correspond to an eHRPD network allows maintenance of the IP context created over the LTE network. That is, seamless application operation is achieved when the UE application is able to maintain the same IP address across an inter RAT (radio access technology) handover in response to an OOS event.

As a further example, a UE may undergo a redirection failure from an LTE network to an EV-DO (evolution data only/optimized) frequency. In response, the UE selection process may scan frequencies listed in a system information block (SIB-8), followed by a scan of the frequencies within a preferred roaming list (PRL). In one aspect of the present disclosure, the eHRPD frequencies in the SIB-8 and/or the PRL are scanned first, which allows the UE to maintain an IP context created over an LTE network.

In another example, following an out of service event on an LTE network, the UE may first acquire a 1x network. Alternatively, the UE may move from an LTE network to a 1x network through a reselection/redirection procedure. In one aspect of the present disclosure, a UE multimode system selection process focuses scans on the eHRPD frequencies in, for example, a co-located DO list from the PRL for maintaining IP continuity. In addition, there are certain applications that work over eHRPD (this can be specified using an application profile, e.g., Voice Over IP). If such an application is started when the UE is on a 1x/HRPD network, the operator might want the UE to look for eHRPD systems for a certain amount of time (depending on the application priority).

According to one aspect of the present disclosure, a UE multimode system selection process is described that includes a priori knowledge of whether a channel frequency corresponds to an HRPD network or an eHRPD network. In one configuration, the UE stores information for PRL channels in a geographic region (GEO) indicating whether the respective PRL channel frequency corresponds to an eHRPD or an HRPD system. In this configuration, the UE multimode system selection is prioritized to focus network scanning on channel frequencies that correspond to eHRPD systems.

In one aspect of the present disclosure, network assistance provides a priori knowledge of whether a channel frequency corresponds to an HRPD network or an eHRPD network. In this aspect of the present disclosure, eHRPD capability information is determined according to an additional parameter included in a system information block (SIB). A conventional SIB provides information regarding neighbor HRPD systems. The SIB, however, does not indicate whether the particular neighbor HRPD system is upgraded to provide eHRPD capability. In this aspect of the present disclosure, where a SIB (e.g., SIB8) is supported on a network, a new parameter (e.g., “is_ehrpd_capable=true or false”) can be used in a ‘parametersHRPD’ block of the SIB to indicate whether a cell is eHRPD capable.

According to a further aspect of the present disclosure, UE learning is used to collect eHRPD capability information. In this aspect of the present disclosure, a SIB is not used or does not indicate whether a cell/ARFCN (absolute radio frequency channel number) corresponds to an HRPD/eHRPD system. Current provisioned databases (e.g., PRL) do not differentiate between eHRPD and HRPD networks. The UE, however, determines eHRPD capability information after acquiring, for example, an EV-DO network and performing a session negotiation, which may be referred to herein as “UE learning”. Conventional UEs do not maintain any knowledge that an eHRPD network was found on a particular frequency. In this aspect of the present disclosure, the eHRPD/HRPD capability information is used by the UE to build eHRPD and HRPD databases.

Thus, the eHRPD/HRPD capability information may be determined through network assistance, and/or UE learning, or the like. In one aspect of the present disclosure, the UE maintains three databases to have knowledge of: (1) information about discovered eHRPD systems; (2) information about discovered HRPD systems; (3) information about systems in which a connection failure occurred; and (4) information about systems that are not yet identified as eHRPD or HRPD.

In one configuration, information about systems in which a connection failure occurred is stored in a negative (or barred) DB (database) for both HRPD and eHRPD systems. In this configuration, the UE avoids scanning these entries or scans entries in the negative DB as a last resort. The UE may also move an entry from the negative DB to a valid database (e.g., eHRPD/HRPD DB) list if a subsequent connection is successful. In a further configuration, the UE can also maintain a timer on the entries in the negative DB, and, upon expiry, move the entry to a valid database list.

In an aspect of the present disclosure, a frequency indicated by the PRL may be tuned to for receiving a channel hashing message in the system parameters message (SPM). The channel hashing message transmitted on the frequency indicated by the PRL may provide multiple frequencies. In this aspect of the disclosure, once the UE identifies a frequencies from the channel hashing message that is eHRPD capable, the UE may assume that each of the frequencies from the channel hashing message are eHRPD capable. In this configuration, the eHRPD DB may be populated at a higher rate based on the assumed eHRPD capability when a frequency from the channel hashing message is eHRPD capable.

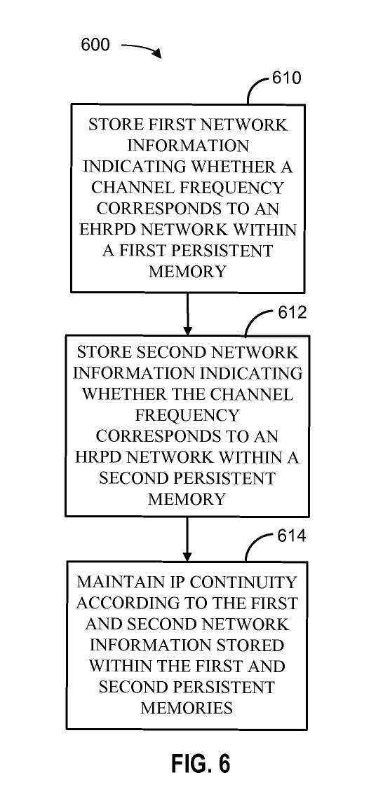

FIG. 6 illustrates a method 600 for performing evolved High Rate Packet Data (eHRPD) network specific scanning, according to another aspect of the present disclosure. In block 610, the UE stores first network information indicating whether a channel frequency corresponds to an evolved High Rate Packet Data (eHRPD) network within a first persistent memory. For example, a UE 120 may store eHRPD capability information with a memory 482, as shown in FIG. 4. In block 612, the UE stores second network information indicating whether the channel frequency corresponds to a High Rate Packet Data (HRPD) network within a second persistent memory. In block 614, the UE maintains Internet Protocol (IP) continuity during an inter-RAT handover, according to the first and second network information stored within the first and second persistent memories.

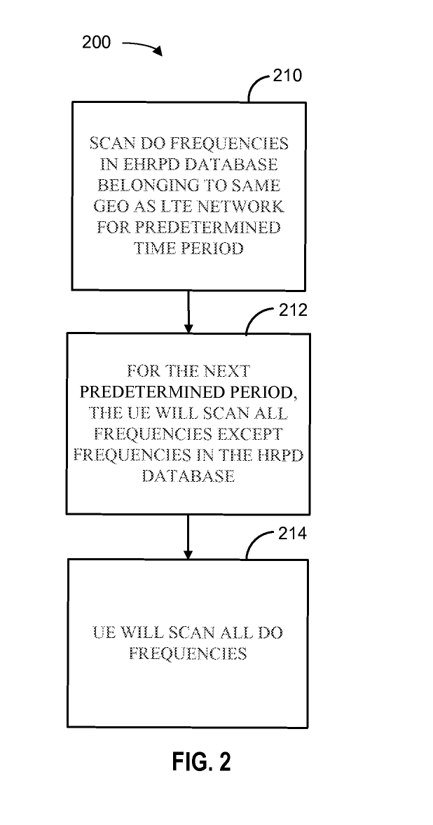

FIG. 2 illustrates a method 200 for performing evolved High Rate Packet Data (eHRPD) network specific scanning in response to an LTE out of service event, according to another aspect of the present disclosure. In block 210, during an EV-DO out of service scan procedure, the UE initially scans the EV-DO frequencies in the eHRPD DB that belong to a same geographic region (GEO) as the LTE network for a predetermined period of time (e.g., N_IP_cont seconds). In block 212, the UE scans all the frequencies in the eHRPD database (e.g., from the PRL with unknown eHRPD capability information), except the ones in the HRPD database, for a next predetermined period of time (e.g., N_IP_cont2 seconds). In block 214, the UE scans all EV-DO frequencies in the eHRPD and HRPD databases, which may result in loss of IP continuity if an HRPD network is found. In a further configuration, the above procedure is also performed if a 1x system is acquired first and UE starts a co-located EV-DO scan.

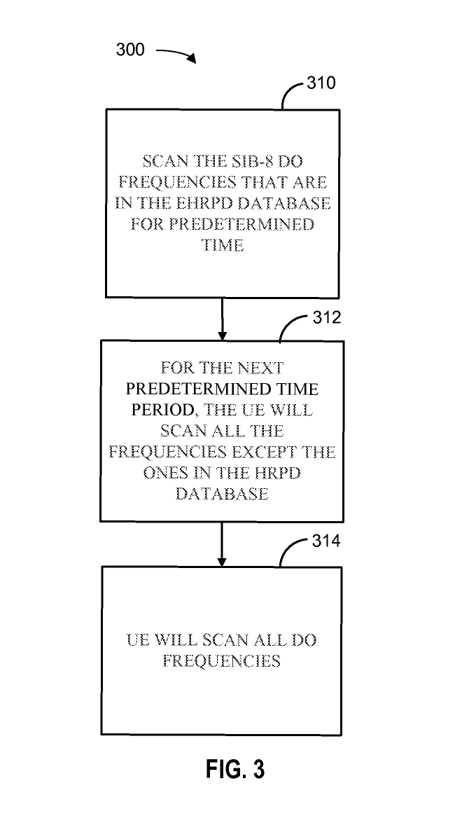

FIG. 3 illustrates a method 300 for performing evolved High Rate Packet Data (eHRPD) network specific scanning in response to an LTE to EV-DO redirection failure, according to another aspect of the present disclosure. In block 310, UE will initially only scan the SIB-8 DO frequencies in the eHRPD database for a predetermined period of time (e.g., N_IP_cont seconds). In block 312, the UE scans all the frequencies in the eHRPD database, except the frequencies in the HRPD database, for a next predetermined period of time (e.g., N_IP_cont2 seconds). In block 314, the UE scans all EV-DO frequencies in the eHRPD and HRPD databases, which may result in loss of IP continuity if an HRPD network is found. In a further configuration, the above procedure is also performed if a 1x system is acquired first and UE starts a co-located EV-DO scan.

Currently, the UE executes a scan for more-preferred LTE systems upon going out of service on HRPD or eHRPD systems. IP continuity is maintained if the EV-DO system lost was an eHRPD system. If an HRPD system is lost, instead of scanning for eHRPD systems, the UE uses the HRPD database entries to scan for HRPD frequencies to prevent IP discontinuity. In a further configuration, if an eHRPD system is lost, scanning for LTE is performed. If an LTE system also cannot be acquired, then instead of scanning for HRPD systems, the UE uses the eHRPD database entries to scan for eHRPD frequencies to prevent IP discontinuity.

In one configuration, the UE 120 is configured for wireless communication including means for storing the first network information. In one aspect, the storing means may be the controller/processor 480 and/or the memory 482, configured to perform the functions recited by the storage means. The UE 120 is also configured to include a means for storing the second network information. In one aspect, this storage means may be the controller/processor 480 and/or the memory 482, configured to perform the functions recited by the storage means. The UE 120 is also configured to include a means for maintaining Internet Protocol (IP) continuity. In one aspect, the maintenance means may be the memory 482, the controller/processor 480, the de/modulators 454a-t and/or the antenna 452a-t configured to perform the functions recited by the maintenance means. In another aspect, the aforementioned means may be any module or any apparatus configured to perform the functions recited by the aforementioned means.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
storing first network information indicating whether a channel frequency corresponds to an evolved High Rate Packet Data (eHRPD) network within a first persistent memory;
storing second network information indicating whether the channel frequency corresponds to a High Rate Packet Data (HRPD) network within a second persistent memory; and
maintaining Internet Protocol (IP) continuity according to the first and second network information stored within the first and second persistent memories.

2. The method of claim 1, further comprising
acquiring a network and performing a session negotiation with the network;
storing eHRPD network information within the first persistent memory when the network is an eHRPD network; and
storing HRPD network information within the second persistent memory when the network is an HRPD network.

3. The method of claim 2, further comprising:
identifying a network as one of an eHRPD network and an HRPD network according to an information field from a system information block (SIB) that identifies when a cell supports eHRPD communications;
storing eHRPD network information within the first persistent memory when the network is an eHRPD network; and
storing HRPD network information within the second persistent memory when the network is an HRPD network.

4. The method of claim 1, further comprising:
storing network failure information indicating whether the channel frequency corresponds to a network in which a failure was previously detected; and
identifying each channel frequency corresponding to a network in which the failure was previously detected as one of an eHRPD network and an HRPD network.

5. The method of claim 1, further comprising scanning for systems that are not yet identified as eHRPD or HRPD.

6. An apparatus configured for wireless communication, the apparatus comprising:
a memory including a first persistent memory and a second persistent memory; and
at least one processor coupled to the memory, the at least one processor being configured:
to store first network information indicating whether a channel frequency corresponds to an evolved High Rate Packet Data (eHRPD) network within the first persistent memory;
to store second network information indicating whether the channel frequency corresponds to a High Rate Packet Data (HRPD) network within the second persistent memory; and
to maintain Internet Protocol (IP) continuity according to the first and second network information stored within the first and second persistent memories.

7. The apparatus of claim 6, in which the processor is further configured:
to acquire a network and performing a session negotiation with the network;
to store eHRPD network information within the first persistent memory when the network is an eHRPD network; and
to store HRPD network information within the second persistent memory when the network is an HRPD network.

8. The apparatus of claim 7, in which the processor is further configured:
to identify a network as one of an eHRPD network and an HRPD network according to an information field from a system information block (SIB) that identifies when a cell supports eHRPD communications;
to store eHRPD network information within the first persistent memory when the network is an eHRPD network; and
to store HRPD network information within the second persistent memory when the network is an HRPD network.

9. The apparatus of claim 6, in which the processor is further configured:
to store network failure information indicating whether the channel frequency corresponds to a network in which a failure was previously detected; and
to identify each channel frequency corresponding to a network in which the failure was previously detected as one of an eHRPD network and an HRPD network.

10. The apparatus of claim 6, in which the processor is further configured to scan for systems that are not yet identified as eHRPD or HRPD.

11. A computer program product configured for wireless communication, the computer program product comprising:
a non-transitory computer-readable medium having non-transitory program code recorded thereon, the program code comprising:
program code to store first network information indicating whether a channel frequency corresponds to an evolved High Rate Packet Data (eHRPD) network within a first persistent memory;
program code to store second network information indicating whether the channel frequency corresponds to a High Rate Packet Data (HRPD) network within a second persistent memory; and
program code to maintain Internet Protocol (IP) continuity according to the first and second network information stored within the first and second persistent memories.

12. The computer program product of claim 11, further comprising:
program code to acquire a network and performing a session negotiation with the network;
program code to store eHRPD network information within the first persistent memory when the network is an eHRPD network; and
program code to store HRPD network information within the second persistent memory when the network is an HRPD network.

13. The computer program product of claim 12, further comprising:
program code to identify a network as one of an eHRPD network and an HRPD network according to an information field from a system information block (SIB) that identifies when a cell supports eHRPD communications;
program code to store eHRPD network information within the first persistent memory when the network is an eHRPD network; and
program code to store HRPD network information within the second persistent memory when the network is an HRPD network.

14. The computer program product of claim 11, further comprising:
program code to store network failure information indicating whether the channel frequency corresponds to a network in which a failure was previously detected; and
program code to identify each channel frequency corresponding to a network in which the failure was previously detected as one of an eHRPD network and an HRPD network.

15. The computer program product of claim 11, further comprising program code to scan for systems that are not yet identified as eHRPD or HRPD.

16. An apparatus configured for operation within a wireless communication network, the apparatus comprising:
means for storing first network information indicating whether a channel frequency corresponds to an evolved High Rate Packet Data (eHRPD) network within a first persistent memory;
means for storing second network information indicating whether the channel frequency corresponds to a High Rate Packet Data (HRPD) network within a second persistent memory; and
means for maintaining Internet Protocol (IP) continuity according to the first and second network information stored within the first and second persistent memories.

17. The apparatus of claim 16, further comprising:
means for acquiring a network and performing a session negotiation with the network;
means for storing eHRPD network information within the first persistent memory when the network is an eHRPD network; and
means for storing HRPD network information within the second persistent memory when the network is an HRPD network.

18. The apparatus of claim 17, further comprising:
means for identifying a network as one of an eHRPD network and an HRPD network according to an information field from a system information block (SIB) that identifies when a cell supports eHRPD communications;
means for storing eHRPD network information within the first persistent memory when the network is an eHRPD network; and
means for storing HRPD network information within the second persistent memory when the network is an HRPD network.

19. The apparatus of claim 16, further comprising:
means for storing network failure information indicating whether the channel frequency corresponds to a network in which a failure was previously detected; and
means for identifying each channel frequency corresponding to a network in which the failure was previously detected as one of an eHRPD network and an HRPD network.

20. The apparatus of claim 16, further comprising means for scanning for systems that are not yet identified as eHRPD or HRPD.
